(19) United States
(12) Patent Application Publication
(10) Pub. No.: US 2006/0097210 A1
(43) Pub. Date: May 11, 2006

(54) Composite armature for vehicle actuator valve

(76) Inventors: Keith B. Fong, El Paso, TX (US); Diana Rubio, El Paso, TX (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/984,423

(22) Filed: Nov. 9, 2004

(51) Int. Cl. F16K 31/02

(52) U.S. Cl. 251/129.15

(57) ABSTRACT

An actuator includes a coil housing supporting an electric coil and a composite armature that is slidably disposed in the housing. The armature has a ferromagnetic core and an overmolded polymeric member that can define one or more of an alignment rib, a damping element, and a valve poppet.

### FIELD OF THE INVENTION

The present invention relates generally to vehicle actuators.

### BACKGROUND OF THE INVENTION

Actuators such as current-controlled, electro-hydraulic valves are used in vehicles in anti-lock braking systems (ABS), traction control systems, stability control systems, automatic transmissions, and other systems. These valves typically use electrically-controlled sliding plungers to selectively permit or prevent fluid flow through the actuator under particular circumstances, as required for the application. The plunger must be ferromagnetic, so that as current is passed through a wire coil that surrounds the plunger, the resulting magnetic force can move the plunger. Because of this aspect of its functionality, the plunger is sometimes referred to as an “armature”. In typical configurations, a spring and/or fluid pressure biases the plunger to a “normal” position inside the actuator when the coil is not energized.

A typical plunger defines a valve element on one end that mates with a primary valve seat which is formed in a valve body of the actuator. Additional valving structure, including plunger rods that extend through the primary valve seat to move a ball toward or away from a secondary valve seat, may be provided in the valve body and coupled in various ways to plunger movement as appropriate to establish two-way valves, three-way valves, and so on.

The present invention, which finds application independent of the particular valving structure, recognizes that a solenoid valve plunger must not only act as an armature and as a valve seat closure element, but depending on the application may also require structure to facilitate guiding the plunger while sliding and cushioning the plunger at the ends of its travel. As further understood herein, some plunger functions demand one particular type of material while other functions might be optimally met using other types of plunger material.

### SUMMARY OF THE INVENTION

An actuator that can establish a release valve for a vehicle anti-lock brake system (ABS) includes a coil housing supporting an electric coil, and a composite armature slidably disposed in the housing. The composite armature includes a ferromagnetic core and an overmolded polymeric member defining an alignment element and/or a damping element and/or a valve poppet.

Non-limiting alignment elements may include ribs that protrude longitudinally along a cylindrical surface of the armature. Non-limiting damping elements may include collars circumscribing a cylindrical surface of the armature. An end of the polymeric member may define a valve poppet that is configured for seating against a seat of a valve body.

In another aspect, a vehicle anti-lock brake system (ABS) release valve includes a coil in a housing and a valve seat. A composite armature is actuatable by the coil to move away from or toward the valve seat. The armature includes a ferromagnetic core and at least one polymeric feature attached to the core. The armature moves to selectively establish a pressure relief path in the ABS.

In yet another aspect, a hydraulic actuator has a coil housing and a wire coil disposed in the housing. A composite armature is reciprocatingly disposed within an annulus defined by the coil and is made of a metal core overmolded with a plastic material which defines an operationally useful feature.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a partial cross-sectional view of an electro-hydraulic valve showing the present composite armature;

FIG. 2 is a perspective view of a first embodiment of the present composite armature, with portions shown in phantom;

FIG. 3 is a perspective view of a second embodiment of the present composite armature, with portions shown in phantom;

FIG. 4 is a perspective view of a third embodiment of the present composite armature, with portions shown in phantom; and

FIG. 5 is a perspective view of a fourth embodiment of the present composite armature, with portions shown in phantom.

### DETAILED DESCRIPTION OF THE PREFERRED EMBODIMENT

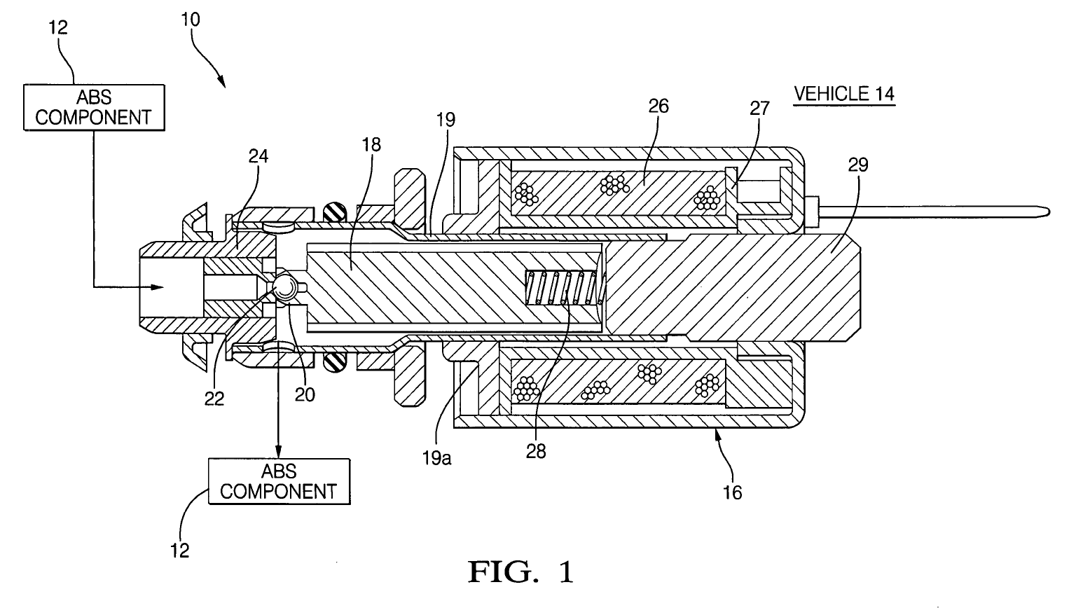

Referring initially to FIG. 1, an actuator is shown, generally designated 10, that can be part of the fluid communication path of a control system 12 of a vehicle 14. The control system 12 may be any suitable control system requiring actuators such as but not limited to anti-lock braking systems (ABS), traction control systems, and stability control systems. The system 12 may include various sensors and a processor in accordance with principles known in the art, with the processor selectively energizing and deenergizing the below-described coil of the actuator 10 based on signals from the sensors as appropriate to control fluid flow through the system 12. In one embodiment the system 12 is an ABS and the actuator 10 is a normally closed ABS release valve, although the principles set forth herein can apply to other types of valves, including normally open valves.

As shown in FIG. 1, the actuator 10 includes a rigid, hollow, preferably ferrous metal coil can 16 in which a composite armature 18, which may be referred to herein as a plunger, is reciprocatingly disposed within an annulus defined by the below-described coil for motion along the long axis of the armature 18. Support structure such as bushings and/or a tube 19 may be provided in the coil can to radially support the below-described alignment features of the armature 18. A lid 19a may be disposed between the tube 19 and coil can 16 as shown.

FIG. 1 shows that the armature 18 may have a frusto-conical shaped valve element 20 or poppet portion formed on one end of the armature 18, it being understood that the particular contour of the valve element 20 can take on other configurations. As can be appreciated in reference to FIG. 1, the valve element 20 can be moved against a complementarily-shaped valve seat 22 that is defined by a valve body 24 which is joined, in some implementations by the tube 19, to the coil can 16. The valve seat 22 defines a fluid passageway. When the armature 18 is in the closed configuration, i.e., against the valve seat 22, fluid flow through the fluid passageway of the valve seat 22 is prevented. On the other hand, when the armature 18 is moved away from the valve seat 22 to an open configuration, fluid flow through the fluid passageway of the valve seat 22 is permitted.

The armature 18 may be actuated by selectively energizing and deenergizing a coil 26 located in the coil can 16. The coil 26 may be wound around a coil bay 27 in the can 16. When the coil 26 is energized an electromagnetic coupling between the coil 26 and armature 18 moves the armature 18 in one direction, while deenergizing the coil 26 causes the armature to move back in the other direction under the influence of a spring 28 which is disposed between a stator (stop) 29 and armature 18. In the embodiment shown the valve is normally closed in that the spring 28 biases the armature 18 against the valve seat 22 with the valve being opened upon energization of the coil, it being understood that other configurations may be provided wherein the valve might be normally open (e.g., because of the influence of fluid pressure against the valve element 20, or by a spring located on the valve seat side) and may be closed upon energization of the coil 26.

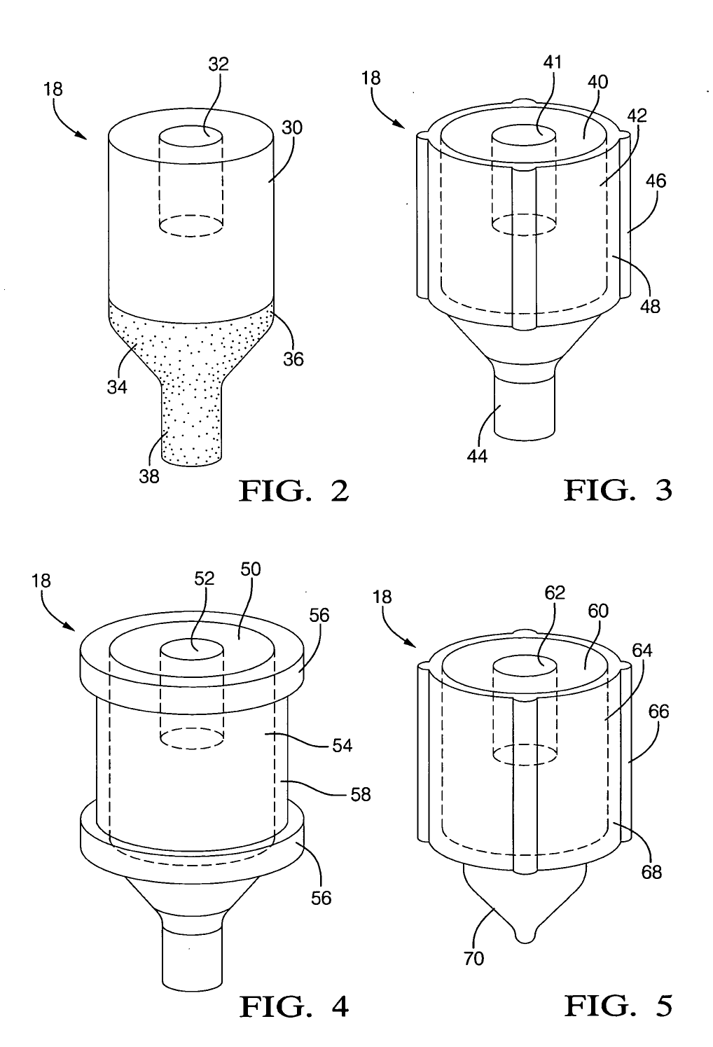

FIG. 2 shows a more detailed view of the armature 18, wherein a cylindrical, substantially solid core 30 of the armature 18 is made of ferrous metal. As shown, at one base of the ferrous metal cylinder 30 a hollow spring pocket 32 may be formed. The spring pocket 32 may be omitted altogether if desired or formed in the stator 29. When formed in the armature 18, the base of the spring pocket 32 is in the same plane as that of the ferrous metal cylinder 30, such that a hollow space is formed in the core into which the spring 28 shown in FIG. 1 can fit.

At the opposite base of the ferrous metal core 30 is a valve element or poppet portion 34 made of polymeric material. This polymeric poppet preferably is overmolded onto an end of the core 30 into any desired shape. Less desirably, the polymeric poppet 34 may be made separately from the core 30 and then attached to the core by, e.g., adhesive bonding.

In the exemplary non-limiting embodiment shown in FIG. 2, a portion 36 of the polymeric poppet 34 is cylindrical, with the contour of the poppet 34 rapidly decreasing in diameter to a narrow portion 38 wherein the diameter is constant. It is to be understood that the poppet 34 may take on other configurations as appropriate, such as the frusto-conical configuration shown in FIG. 1, to mate with complementarily-shaped valve seats.

FIG. 3 displays an alternate embodiment of the armature 18 which in all essential respects is identical in configuration to the armature shown in FIG. 2, with the following exceptions. A ferrous core 40 is completely overmolded (except for the base with a spring pocket 41) with polymer material 42. The overmold of polymer material 42 is characterized by both a poppet portion 44 and at least one raised alignment feature 46 on an otherwise cylindrical surface portion 48. In the embodiment shown in FIG. 3, four alignment features 46 are shown, with each alignment feature 46 essentially being a longitudinally oriented rib that is raised from the cylindrical surface portion 48. The ribs are radially spaced equally from each other by ninety degrees. The alignment features 46 thus extend parallel to a longitudinal axis defined by the ferrous metal core 40 to guide and radially support the armature 18 as it reciprocates within the actuator 10.

FIG. 4 displays yet another alternate concept of the armature 18 that has a ferrous metal core 50 formed with a hollow spring pocket 52 and that is overmolded with polymer material 54. The polymer overmold defines at least one and in the embodiment shown in FIG. 4 two damping features such as collars 56 near opposite bases of the ferrous metal core 50. Each collar 56 protrudes radially from an otherwise cylindrical surface 58 of the overmolded polymer material, and each collar 56 circumscribes the surface 58. The damping features may or may not impact other structure, but in any case restrict fluid flow around the armature to dampen armature acceleration.

FIG. 5 displays an alternate concept of the armature 18 that in all essential respects is identical in configuration to those shown above, with the following exceptions. A metal core 60 with spring pocket 62 is overmolded with polymer material 64 that defines raised alignment features 66, but that covers only a larger diameter portion 68 of the metal core 60. The ferrous metal core 60 is similar in form to that described in previous figures except that the core 60 is tapered down to a poppet portion 70 which protrudes out of the polymer overmold. The ferrous metal core 60 thus is extended to form the poppet of the actuator 10.

While the particular COMPOSITE ARMATURE FOR VEHICLE ACTUATOR VALVE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. An actuator, comprising:
a coil housing supporting an electric coil; and
a composite armature slidably disposed in the housing, the armature including a ferromagnetic core and at least one overmolded polymeric member defining at least one of the group consisting of: an alignment element, a damping element, and a valve poppet.

2. The actuator of claim 1, wherein the polymeric member defines an alignment element.

3. The actuator of claim 2, wherein the alignment element includes at least one rib protruding longitudinally along a cylindrical surface of the armature.

4. The actuator of claim 1, wherein the polymeric member defines a damping element.

5. The actuator of claim 4, wherein the damping element includes at least one collar circumscribing a cylindrical surface of the armature.

6. The actuator of claim 1, wherein an end of the polymeric member defines a valve poppet configured for seating against a seat of a valve body.

7. The actuator of claim 1, wherein the actuator is operably engaged with a vehicle anti-lock brake system (ABS), the actuator establishing an ABS release valve.

8. A vehicle anti-lock brake system (ABS) release valve, comprising:
a coil in a housing;
at least one valve seat; and
a composite armature actuatable by the coil to move away from or toward the valve seat, the armature including a ferromagnetic core and at least one polymeric feature attached to the core, the armature moving to selectively establish a pressure relief path in the ABS.

9. The release valve of claim 8, wherein the polymeric feature is overmolded onto the core.

10. The release valve of claim 8, wherein the polymeric feature defines an alignment element.

11. The release valve of claim 10, wherein the alignment element includes at least one rib protruding longitudinally along a cylindrical surface of the armature.

12. The release valve of claim 8, wherein the polymeric feature defines a damping element.

13. The release valve of claim 12, wherein the damping element includes at least one collar circumscribing a cylindrical surface of the armature.

14. The release valve of claim 8, wherein an end of the polymeric feature defines a valve poppet configured for seating against a seat of a valve body associated with the housing.

15. A hydraulic actuator, comprising:
a coil housing;
a wire coil disposed in the housing; and
a composite armature reciprocatingly disposed within an annulus defined by the coil and made of a metal core overmolded with a plastic material defining at least one feature operationally useful.

16. The actuator of claim 15, wherein the feature defines an alignment element.

17. The actuator of claim 16, wherein the alignment element includes at least one rib protruding longitudinally along a cylindrical surface of the armature.

18. The actuator of claim 15, wherein the feature defines a damping element.

19. The actuator of claim 18, wherein the damping element includes at least one collar circumscribing a cylindrical surface of the armature.

20. The actuator of claim 15, wherein the feature defines a valve poppet configured for seating against a seat of a valve body.

21. The actuator of claim 15, wherein the actuator is operably engaged with a vehicle anti-lock brake system (ABS), the actuator establishing at least one of: an ABS release valve, and an ABS apply valve.
